(19) United States
(12) Patent Application Publication
(10) Pub. No.: US 2017/0071399 A1
(43) Pub. Date: Mar. 16, 2017

(54) BEVERAGE PRESS APPARATUS AND METHOD

(71) Applicant: ESPRO INC., Vancouver (CA)

(72) Inventors: Bruce A. CONSTANTINE, Vancouver (CA); Christopher R. MCLEAN, Vancouver (CA)

(21) Appl. No.: 15/260,151

(22) Filed: Sep. 8, 2016

Related U.S. Application Data
(60) Provisional application No. 62/217,562, filed on Sep. 11, 2015.

(51) Int. Cl. A47J 31/44; A47J 31/18

(52) U.S. Cl. CPC A47J 31/4403; A47J 31/18

(57) ABSTRACT

A Beverage press apparatus includes a substantially cylindrical container, a protruding element fixedly coupled to an external side of the container and a housing laterally enclosing the container, the housing having an aperture. The container may be inserted or removed from the housing when the protruding element is aligned with the aperture of the housing; and when the protruding element is not aligned with the aperture, axial movement of the container with respect to the housing is restricted and/or prevented.

### CROSS REFERENCE TO RELATED APPLICATIONS

This patent application is filed under 35 U.S.C. §111(a) and claims the benefit of priority under 35 U.S.C. §119(e) to U.S. Provisional Patent Application Ser. No. 62/217,562, filed Sep. 11, 2015, which is incorporated by reference herein in its entirety for any purpose whatsoever.

### BACKGROUND OF THE INVENTION

### Field of the Invention

The subject matter disclosed herein relates generally to beverage preparation and more particularly to a beverage press and apparatus.

### DESCRIPTION OF THE RELATED ART

Beverage presses used, for example, for preparing coffee, typically include a cylindrical container for holding fluid and a cage-like housing for securing the glass. A conventional way to secure the container in a Beverage press is to employ friction between the housing and the container. One common method to achieve such friction is by employing a spring-like element, such as a bent metal section which effectively grips the container. In another common method, a handle is threaded to a metal band surrounding the container using a screw, which causes the band to grip the container tightly.

These methods have been found to suffer from certain drawbacks. In the first method, over time, the grip of the spring-element generally loosens; for example, the spring element bends tends to bend outward and encircling bands employed tend become rounded, with the result that the container may not be retained properly. Similarly, in the second method, the screw may loosen with repeated use, or after disengaging the glass for cleaning the screw may thereafter not be tightened enough (e.g., accidentally), also resulting in an insufficient retention of the container within the housing.

It would be helpful to improve upon the conventional methods for retaining the container within the housing of a Beverage press.

### SUMMARY OF THE INVENTION

The present disclosure provides a Beverage press apparatus that comprises a substantially cylindrical container, a protruding element fixedly coupled to an external side of the container and a housing laterally enclosing the container, the housing having an aperture. The container may be inserted or removed from the housing when the protruding element is aligned with the aperture of the housing; and when the protruding element is not aligned with the aperture, axial movement of the container with respect to the housing is restricted and/or prevented.

The present disclosure also provides a Beverage press apparatus that comprises a substantially cylindrical container, a coupling element fixedly coupled to an external side of the container, the coupling element having a shaped surface, a housing laterally enclosing the container having at least two flange elements and a handle having a first end, the first end having an extension with a surface adapted to fit into the shaped surface of the coupling element, the first end also adapted to fasten to one of a first of the at least two the flange elements, and a second end adapted to fasten to a second of the at least two flange elements. Fastening either the first end of the handle to the first flange element or the second end of the handle to the second flange element restricts axial movement of the container.

The apparatus and methods of the present invention provide improved retention of the container in Beverage presses and thereby prevent accidental breakage or other damage that might occur if the container is not retained within the housing.

### BRIEF DESCRIPTION OF THE FIGURES

FIG. 1 is an exemplary front plan view of a Beverage press according to an embodiment of the present invention;

FIG. 2 is an exemplary vertical cross-sectional view illustrating a coupling element adhesively bonded to a container and adapted for coupling to a handle of a Beverage press according to an embodiment of the present invention;

FIG. 3A is an exemplary perspective view illustrating details of an exemplary coupling element bonded to the container of a Beverage press according to an embodiment of the present invention;

FIG. 3B is an exemplary additional perspective view, from above and clockwise with respect to the view of FIG. 3A, illustrating details of the bonding between the coupling element and the container of a Beverage press according to an embodiment of the present invention;

FIG. 4A is an exemplary view illustrating the coupling between the end of a handle and container of a Beverage press via a coupling element according to an embodiment of the present invention;

FIG. 4B is an exemplary vertical cross-sectional view illustrating the coupling between the end of a handle and container of a Beverage press via a coupling element according to an embodiment of the present invention;

FIG. 5A illustrates a typical accident scenario in which the Beverage press is tipped over, and in which the fastening member according to an embodiment of the present invention has been removed from the first handle end;

FIG. 5B illustrates a typical accident scenario in which the Beverage press is tipped over, and in which the fastening member according to an embodiment of the present invention has been removed from the second handle end;

FIG. 6 is an exemplary front plan view of a Beverage Press container including a protruding element according to an embodiment of the present invention;

FIG. 7A is an exemplary front perspective view of a protruding tab element according to an embodiment of the present invention;

FIG. 7B is an exemplary rear perspective view of a protruding tab element according to an embodiment of the present invention;

FIG. 8 is an exemplary front plan view of a Beverage press according to an alternative embodiment of the present invention;

FIGS. 9A to 9E are exemplary perspective views illustrating a process of inserting a container into a Beverage Press housing according to an embodiment of the present invention

FIG. 10 is an exemplary side plan view of a Beverage press according to an alternative embodiment of the present invention;

FIG. 11A is an exemplary cross sectional view of a Beverage press including a bottom twist lock retention mechanism in an open position according to an embodiment of the present invention.

FIG. 11B is an exemplary bottom plan view of a Beverage press including bottom twist lock retention mechanism in an open position according to an embodiment of the present invention.

FIG. 11C is an exemplary cross sectional view of a Beverage press including a bottom twist lock retention mechanism in a closed position according to an embodiment of the present invention.

FIG. 11D is an exemplary bottom plan view of a Beverage press including bottom twist lock retention mechanism in a closed position according to an embodiment of the present invention.

FIG. 12A is an exemplary cross sectional via of a Beverage press including a threaded hole for receiving a screw element according to an embodiment of the present invention.

FIG. 12B is an exemplary cross sectional via of a Beverage press illustrating a screw received into the threaded hole for retaining the container according to an embodiment of the present invention.

FIG. 13A is a an exemplary cross sectional view of a Beverage press including a hook element retention mechanism according to an embodiment of the present invention.

FIG. 13B is an exemplary isometric view of a Beverage press including a hook element retention mechanism according to an embodiment of the present invention.

FIG. 13C is an exemplary rotated cross sectional view of the housing of the embodiments shown in FIGS. 13A and 13B showing the hook fastener in greater detail.

### DETAILED DESCRIPTION

Descriptions herein of the apparatus and methods of the present disclosure as depicted in the Figures represent conceptual embodiments of systems embodying the principles of the disclosed embodiments. It should be understood that these figures and embodiments are exemplary in nature and in no way serve to limit the scope of the disclosure.

It is noted that the term “couple” as used herein means to “connect” either directly or indirectly. For example, if element A is in direct contact with element B, and element B is in direct contact with element C, while element C is not in direct contact with element A, elements A and C may still be said to be coupled to each other via element B.

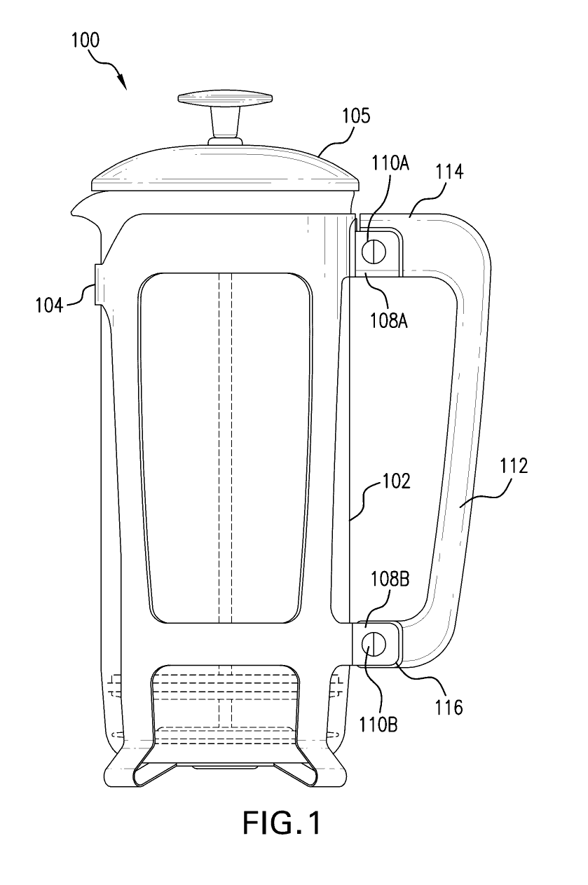

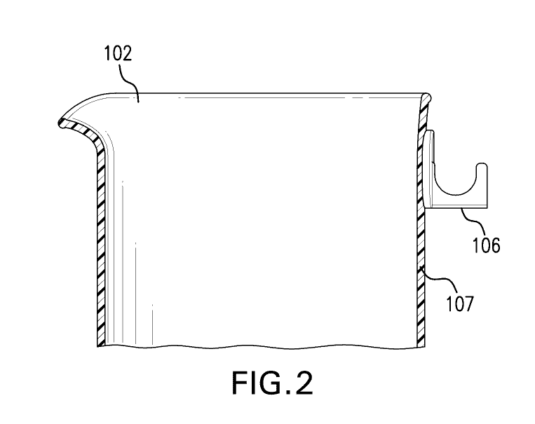

FIG. 1 is an exemplary front plan view of a first embodiment of a Beverage press apparatus 100 according to the present invention. The apparatus 100 comprises a substantially cylindrical container shaped, for example, as a beaker 102, which is enclosed within a housing 104. The container 102 may be composed of glass, plastic or ceramic. The housing 104 may be formed in a variety of different ways; in the example shown, it is formed as a metallic frame or cage which is open at the top end, allowing the container 102 to be moved axially (up or down) and removed from the housing 104 when not otherwise fastened (as will be described below), while the housing surrounds the container circumferentially and confines any lateral movement of the container. A top plunger 105 extends axially through the container 102. Referring now to FIG. 2 which is a cross-sectional view of a top portion of container 102, a coupling element 106 is shown fixed to the external side 107 of container 102. In the depicted embodiment, the coupling element 106 is J-shaped or hooked, but the coupling element may be shaped differently. In one advantageous embodiment, in which the container is made of glass, the coupling element 106 may be made from ABS (Acrylonitrile butadiene styrene), a durable material with high impact resistance. The coupling element 106 may be bonded to the external side 107 of the container 102 using a suitable adhesive particularly adapted for bonding ABS and glass, which securely adheres the coupling element on side 107.

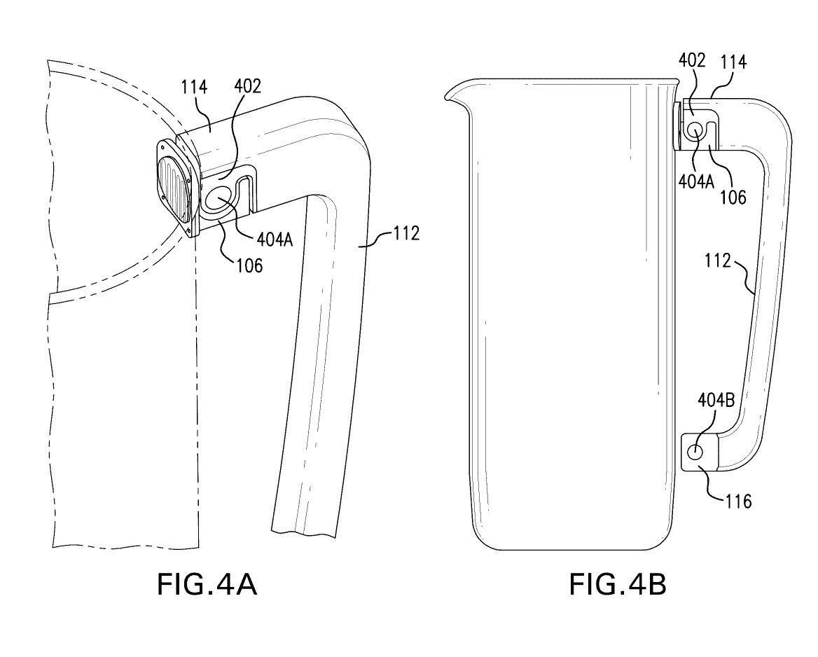

Referring again to FIG. 1, the housing 104 includes outwardly extending flanges 108a, 108b having respective bore holes (not shown in FIG. 1) adapted for receiving a fastening member such as a screw or bolt 110a, 110b. Flanges 108a, 108b are used to securely fasten a handle 112 to the housing 104. In particular, a first end 114 of the handle 112 is shaped in such a way as to cooperate and engage with the coupling element 106. For example, in the embodiment shown in FIG. 2 in which the coupling element is a J-shaped hook, the first handle end 114 may have a complimentary ‘U’ shaped protrusion that is able to fit snugly into the coupling element 106 (the cooperative engagement between the coupling element 106 and the first end 114 of the handle 112 is shown more clearly in FIG. 4A described more fully below) in a ‘tongue-and-groove’ fashion. It is noted however that the cooperative engagement between the coupling element 106 and the first handle end 114 can be achieved in many different ways. For example, instead of a J-shaped profile, the coupling element may have a V-shaped profile and the first handle end 114 may have a corresponding upside-down V shape (or section) adapted to be received into the coupling element 106. Alternatively, instead of a tongue-and-groove shape matching, the coupling between first handle end 114 and the coupling element 106 may employ a snap-fit connection, or any other suitable coupling that enables the handle to act as a stop, restricting axial movement of the container 102.

First handle end 114 also includes a bore hole extending through its width. Upon fitting the handle end onto to fitted into coupling element 106, flange element 108a is adapted to enclose and secure the first handle end 114 in position on the coupling element 106. For example, a fastening member 110a such as a screw or bolt may be passed through corresponding aligned bore holes in the flange element 108a and the first handle end 114, and secured in a nut member on the opposite side, thereby fastening the combined assembly of hook element 106, handle end 114 and flange element 108a.

Similarly, a second handle end 116 may be enclosed and secured by second flange element member 108b and fastening member 110b, in this case without the presence of a coupling element. In this manner, the housing 104 is directly coupled to the handle 112 in two positions via the flange elements 108a, 108b. These couplings between the housing 104 and the handle 112 prevent unintended axial movement of the container out of the housing as will be described in further detail below.

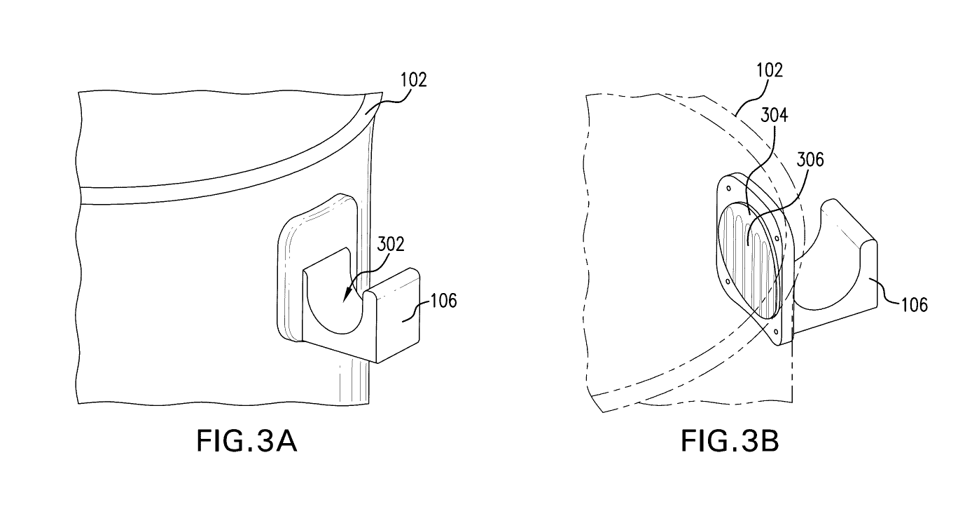

FIG. 3A is an exemplary perspective view showing the coupling element 106 coupled to the external side 107 of container 102. As shown, the J-shaped coupling element 106 defines a semi-circular space 302 adapted to receive a corresponding element of handle 112. FIG. 3B is another exemplary perspective view that depicts adhesion of a surface 304 of the coupling element 106 to the container 102 by means of an adhesive or glue material 306.

FIG. 4A is a perspective view that more specifically illustrates a coupling between the first handle end 114 and coupling element 106 according to an embodiment of the present invention. As shown, the first handle end 114 includes an extending semicircular portion 402 that is adapted to fit into the semi-circular space 302 of the coupling element 106. The extending portion 402 includes a bore hole 404a for receiving fastening member 110a (not shown in FIG. 4A). FIG. 4B is a plan view illustrating the same coupling. This view more clearly depicts the second handle end 116 having bore hole 404b adapted to receive fastening member 110b.

In operation, it is generally preferable to fasten both ends 114, 116 of the handle 112 to flanges 108a, 108b of the housing 104. However, if either end of the handle 112 is unfastened or otherwise comes loose, axial movement of the container 102 can still be restricted by the other coupled handle end; in other words, so long as the handle 112 remains attached to the housing, axial movement of the container 102 can be restricted, preventing accidents.

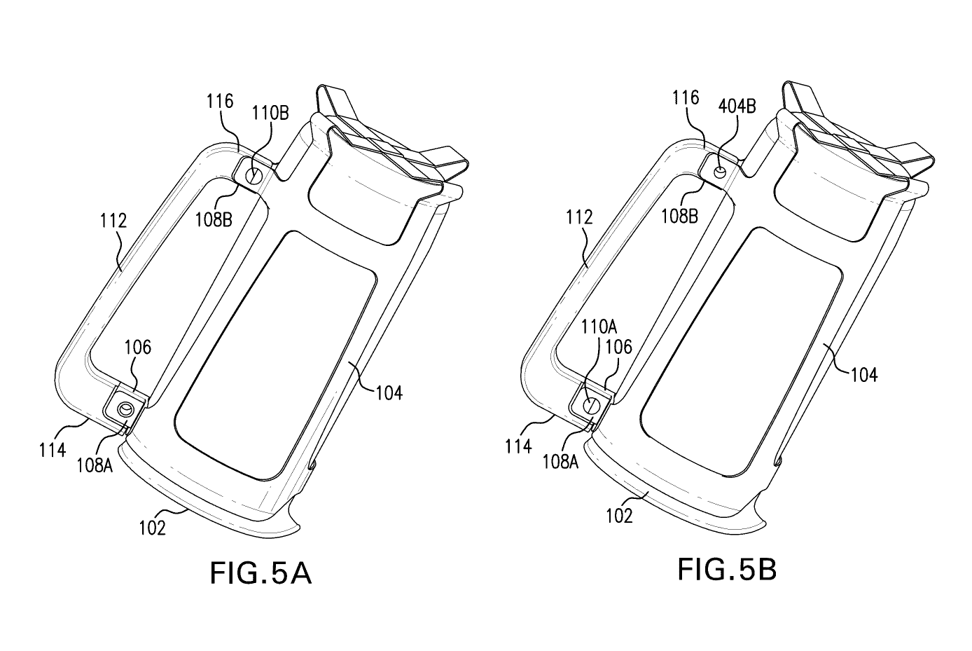

For example, FIG. 5A illustrates a typical accident scenario in which the Beverage press 100 is tipped over, and in which the fastening member has been removed from the first handle end 114. In this scenario, the second handle end 116 remains firmly fastened to the housing 104 via the fastening member 110b which fastens the second flange element 108b of the housing to the second handle end 116. Accordingly, being fastened at one location, the handle 112 as a whole cannot move axial relative to the housing. Although the force of gravity applies a downward force on the container 102, the immobility of the handle 112 provided by the fastening at the second handle end 116 is sufficient to prevent axial movement of the container 102. This is due to the fact that the first handle end 112 rests above the coupling element 106 attached to the container 102, thereby blocking any axial movement of the container as long as the handle 112 itself does not move. Accordingly, in order for the container 102 to fall out of Beverage press 100, the force of gravity acting on coupling element 106 would need to force the first handle end 112 outwards. This is prevented mainly by fastening of the second handle end 116 and also by the snugness of the fit between the shaped extension 402 and the matching receiving space 302 of the coupling element.

In FIG. 5B an alternative accident scenario in which the Beverage press 100 is tipped over, and in which the fastening member has been removed from the second handle end 116, is illustrated. In this scenario, the first handle end 114 remains firmly fastened to the housing 104 via the fastening member 110a which fastens the first flange element 108a of the housing to the first handle end 104. In this case, the axial location first handle end 112 is fixed, blocking the coupling element 106 and thereby the container 102 from axial motion beyond the point of the first flange element 108a. Thus, in either scenario, a single fastening at either the first or second handle ends is sufficient to retain the container within the housing and prevent accidental breakage even when the Beverage press is tipped over.

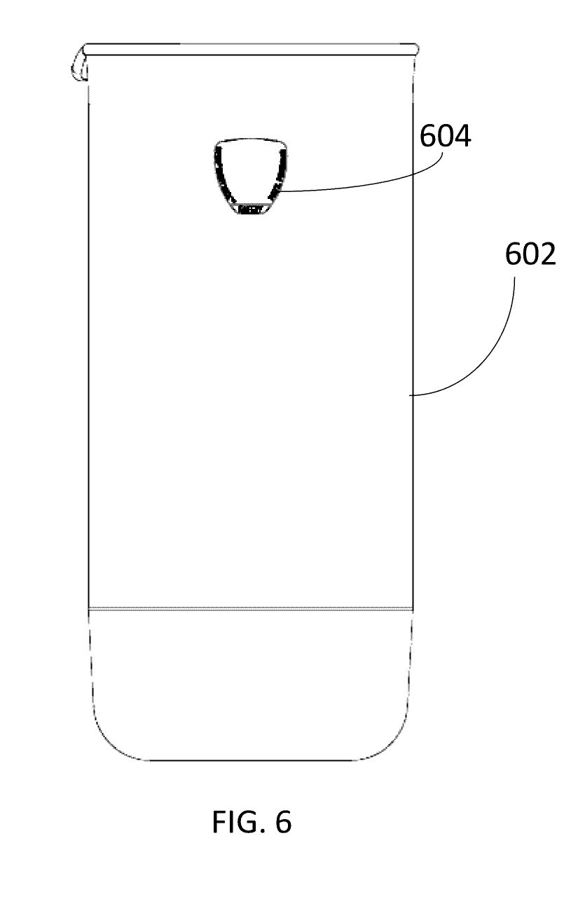

The present invention also provides additional embodiments of Beverage Presses including alternative mechanisms for ensuring container retention. FIG. 6 shows a container 602 including a protruding element 604 such as a tab on its external surface. In some embodiments, the tab may be an integral part of the container, formed during a molding process; in alternative embodiments, the tab 604 may an independent component coupled to the external surface of the container. In one advantageous embodiment, in which the container is made of glass, the protruding tab element 604 may be from ABS (Acrylonitrile butadiene styrene), and may be bonded to the external side 107 of the container 102 using a suitable adhesive particularly adapted for bonding ABS and glass. However, different materials and adhesives may also be used in other embodiments.

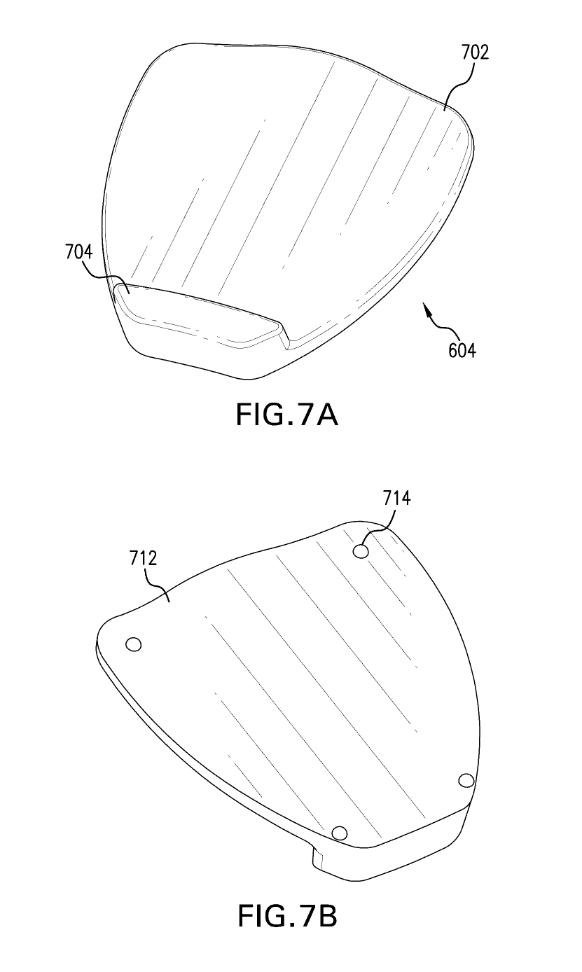

FIGS. 7A and 7B show front and rear perspective views of the tab protruding element according to an embodiment of the present invention. As shown in FIG. 7A, tab 604 has an outer surface 702 that may be oval or shield-shaped as shown, but may equally be formed in other shapes. The width and thickness of the outer surface 702 of the tab are set (e.g., by molding) to enable the tab to fit through an aperture in the Press housing for insertion of the glass into the Press, as will be described further below. In exemplary embodiments, the width may be between 0.75 and 2 cm. and the thickness may be 1.5-4 mm; however other dimensions may be used. The tab 604 includes a ledge 704 at the bottom of the outer surface 702. The purpose of the ledge 704 is to act as an extension of the container surface which abuts a bottom edge of a part of the Press housing cage; if the Press is accidentally overturned, since the ledge 704 abuts an edge, it forms a stop, preventing the glass from moving in an axial direction out of the Press. In some embodiments, depending upon the thickness of the housing, the ledge 704 may extend 2-5 millimeters outwardly from the surface of the tab 702, sufficient to ensure that the housing cannot slip past the ledge.

The inner surface 712 on the reverse side of the tab 602, shown in FIG. 7B, may include bosses, e.g., 714, which narrowly separate the inner surface 712 of the tab from the external surface of the glass (e.g., by 1-2 mm.), providing space for application and setting of the adhesive used to bond the tab to the container (in those embodiments in which the tab is an independent component).

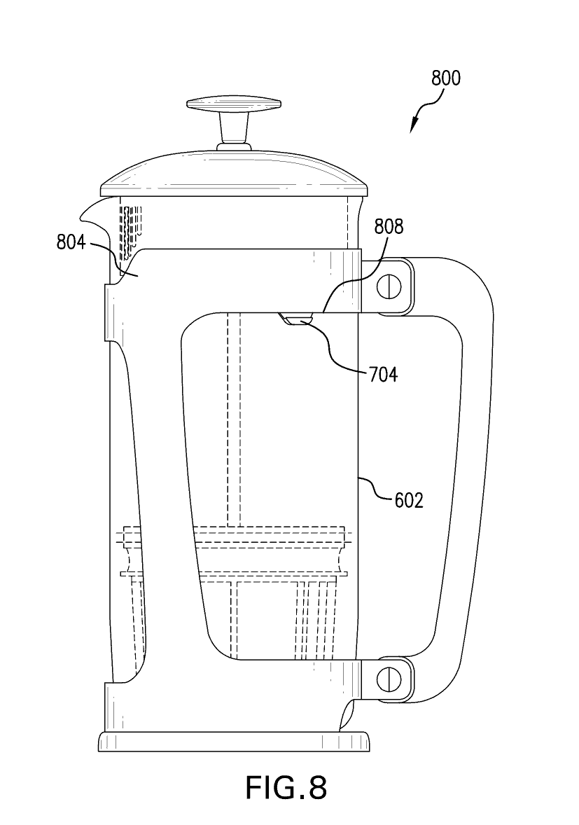

FIG. 8 shows an embodiment of Beverage press 800 in which a container 602 including a protruding tab element as depicted in FIG. 6 is installed in a cage-style housing 804, similar to the housing shown in FIG. 1. As shown, a bottom edge 808 of an upper portion of housing 804 abuts the ledge 704 of the protruding tab 604. If an attempt is made to remove the container 602, it will be prevented from doing so as the ledge 704 will catch on and be stopped by the edge 808 of the housing, preventing axial movement. Since axial movement is prevented in the embodiment of the Beverage Press shown of FIG. 8, in order to install or remove the container 602 into or out of housing 804, the container and protruding tab 604 must be rotated to align the tab with an aperture (not shown in FIG. 8) in the housing large enough so that the ledge clears the housing.

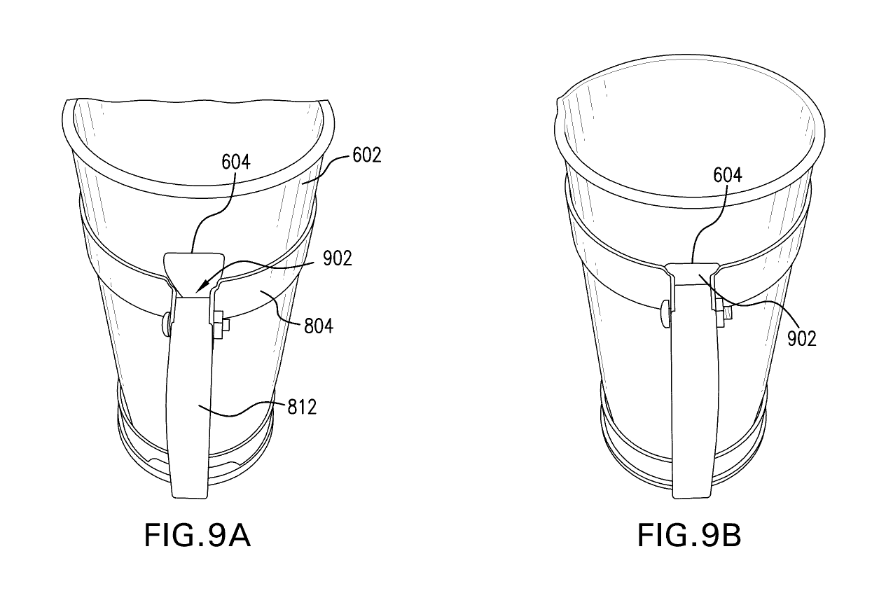

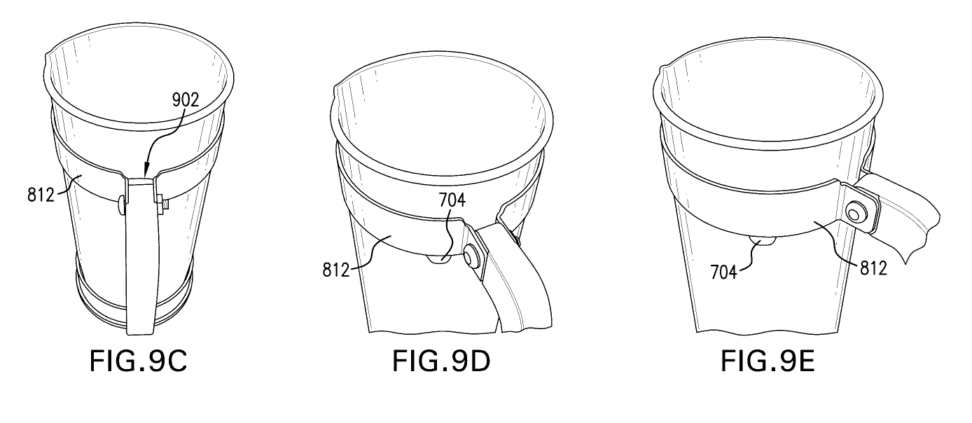

FIG. 9A-9E are a series of perspective views depicting an insertion and subsequent securing of a container 602 in a housing 804 according to an embodiment of the present invention. In a first insertion step, shown in FIG. 9A, the container 602 is rotated to align protruding tab element 604 with an aperture 902 where the housing 804 bends radially outwards. In the depicted embodiment, the aperture 902 is formed where the housing forms a flange used for coupling a handle element 812. The aperture 902 in this embodiment comprises the space at the base of the flange between the handle 812 and container 602. Although this is one convenient way to form the aperture, the aperture can be formed at other portions of the housing by distending or removing a section the housing, for example. In a second step, shown in FIG. 9B, the protruding tab element 604 is inserted through the aperture 902 and the container 602 is lowered into the housing 804. In FIG. 9C, the tab 604 is inserted still further such that the ledge 704 (not shown in FIG. 9C) emerges below the edge 812 of the housing. In third step, shown in FIGS. 9D and 9E, the container 602 is rotated in a clock-wise direction, dis-aligning the tab 604 with the aperture and rotating the tab sufficiently far to avoid accidental alignment. In particular, as shown in the FIGS. 9D and 9E, the ledge 704, which extends below and outwardly from edge 812 of the container, has been rotated from a first angular position closer to the aperture 902 to second angular location further away from the aperture. In the position shown in FIG. 9E, the container 9E cannot be moved out of the housing, either intentionally or accidentally, as the ledge 704 will catch on the edge 812 of the housing, preventing axial movement of the container. Conversely, removal of the container may proceed only by rotating the container back to bring the tab into alignment with the aperture 902. In this manner, retention of the container is ensured.

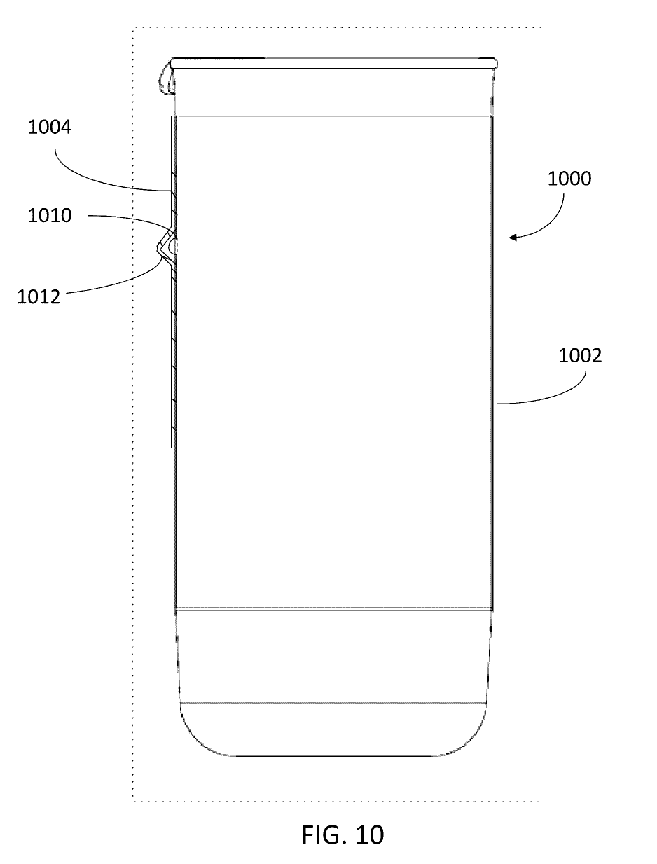

FIG. 10 is a schematic cross-sectional view depicting still another embodiment of a Beverage Press 1000 according to an embodiment of the present invention. In this embodiment, the container 1002 also includes a protruding element 1010, but the protruding element does not necessarily include a ledge but may have an arbitrary shape, such as a rounded, boss-like feature as shown. The housing 1004 in this embodiment may comprise a solid wall fully enclosing the glass, rather than a cage, and may include an outward extension 1012 adapted to corresponding in shape and dimensions with the protruding element 1010 and to enclose the protruding element 1010 when installed. As in the other embodiments, axial movement of the container may restricted and/or prevented by the abutment of the protruding element with the extension 1012. As in other embodiments, the container 1002 may be inserted or removed from the housing 1004 by rotating the protruding element 1010 into alignment with an aperture in the housing (not shown in FIG. 10).

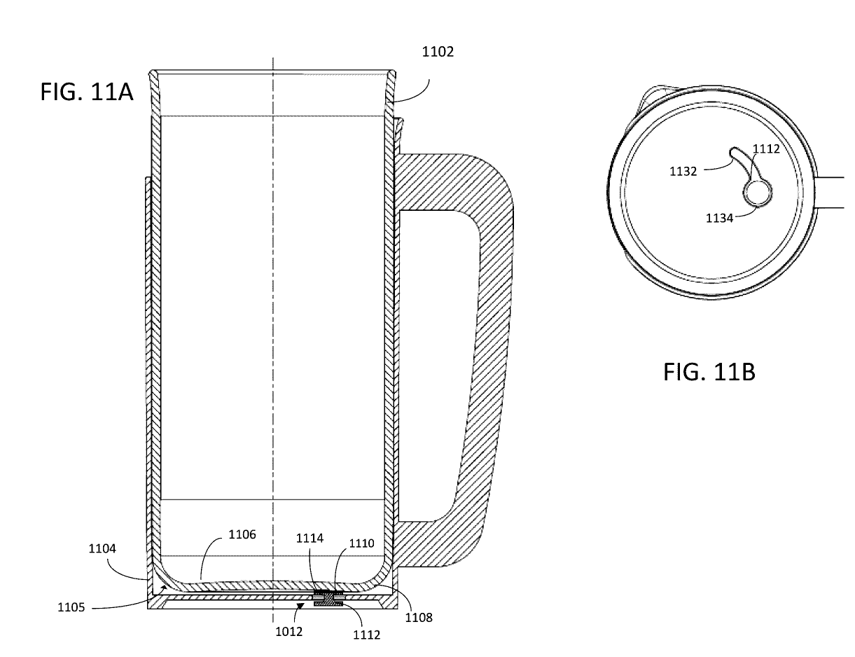

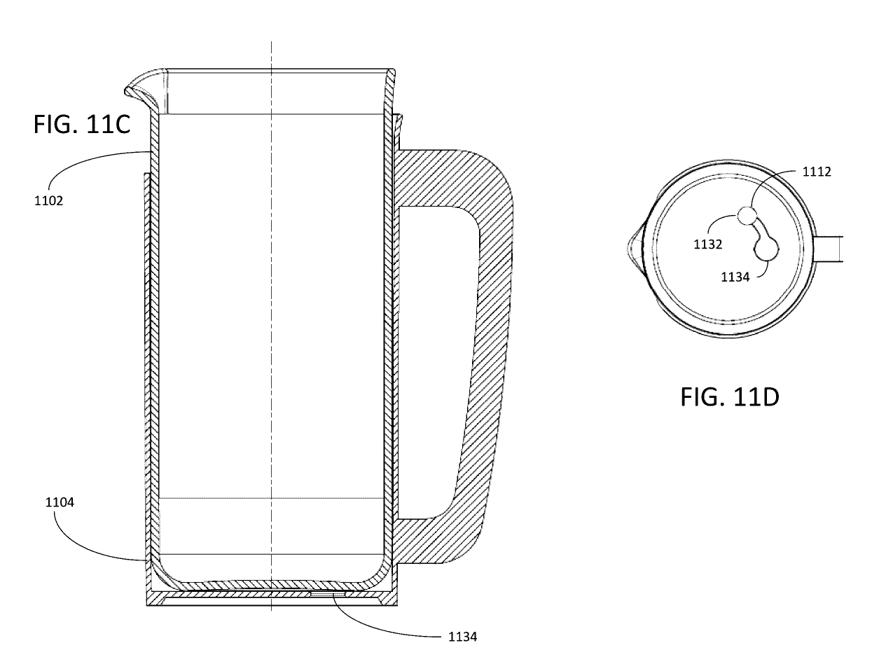

FIGS. 11A to 11D illustrate another Beverage Press container retention mechanism including a bottom twist lock. As shown in cross-sectional view in FIG. 11A, a Beverage Press container 1102 has a bottom portion 1105 having internal and external surfaces 1106, 1108. An extension pin 110, which may be made of ABS or any other suitable material is coupled to the external surface 1108. In the exemplary embodiment shown in FIG. 11A, the pin 1110 is approximately T-shaped in cross-section but may have a different form, so long the head section 1112 of the pin 1110 is wider than a shaft section 114. As shown in the figure, the pin 1110 extends through a wide section of a 1120 in housing 1104 when the container 1102 is fully inserted and seated in the housing. In this position, the hole 1120 is at least as wide as the bottom of the pin and the container can be removed from the housing 1104 and this is therefore is termed an “open” position. FIG. 11B shows a bottom plan view of the housing 1104 illustrating that the hole in the bottom of the housing has a track shape having a narrow track portion 1132 and a wide section 1134 which is at least as wide as the head of the pin 1112.

The purpose of the track is to retain the container in the housing when the container is moved from the ‘open’ position shown in FIGS. 11A and 11B to a ‘closed’ position as shown in FIGS. 11C and 11D. FIG. 11C shows a cross-sectional view of the press after rotation in which the pin 1110 has been rotated and no longer occupies the wide section 1134 of the hole. FIG. 11D is a bottom plan view illustrating how the shaft of pin 1110 has been rotated counter-clockwise along the narrow section 1132 of the hole. As illustrated, the head 1112 of the pin 1110 is wider than the narrow section 1132 in the closed position. Accordingly, if the Beverage Press is turned over or an attempt were made to remove the container, it would be prevented from doing so as the head of the pin attached to the container would be not fit through the hole 1120 of the housing and would therefore be stopped.

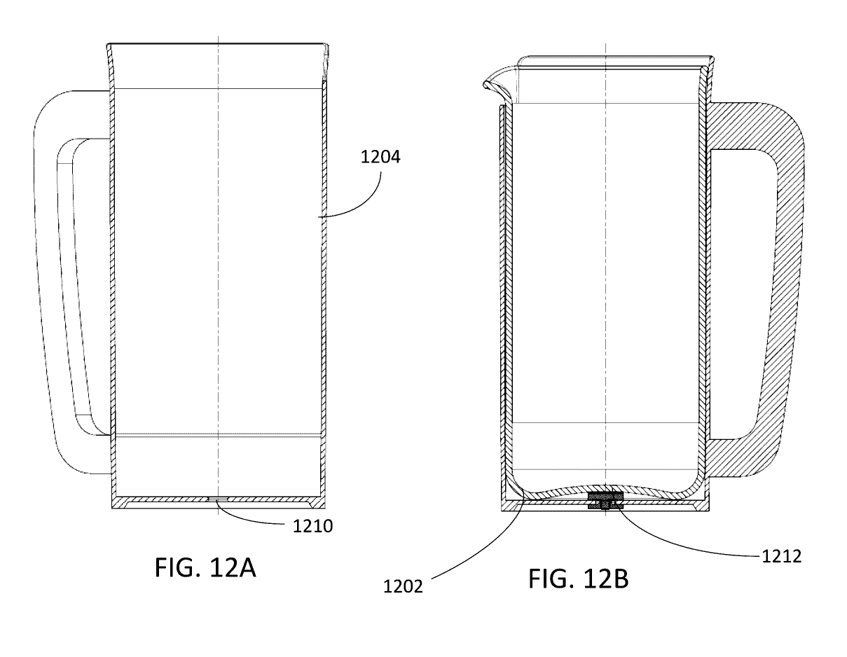

In a related embodiment, in which the container is also secured via its bottom portion, shown in cross-section in FIGS. 12A and 12B, the housing 1204 of a Beverage Press has a central threaded hole 1210. As indicated in FIG. 12B, a threaded member 1212 may be secured to the bottom of container 1202, for example by use of an adhesive as described in the embodiments above, or the threaded member 1212 may be an integral part of the container. The threaded member 1212 is adapted to screw into the threaded hole 1210. In this manner, by rotation of the container the threaded member 1212 may be advanced into the threaded hole 1210 and fasten the container to the housing 1212. Alternatively, instead of including a threaded aperture, the housing may simply include a hole through which the threaded member may be inserted and a nut may be applied to the reverse side of the bottom of the housing to fasten the threaded member.

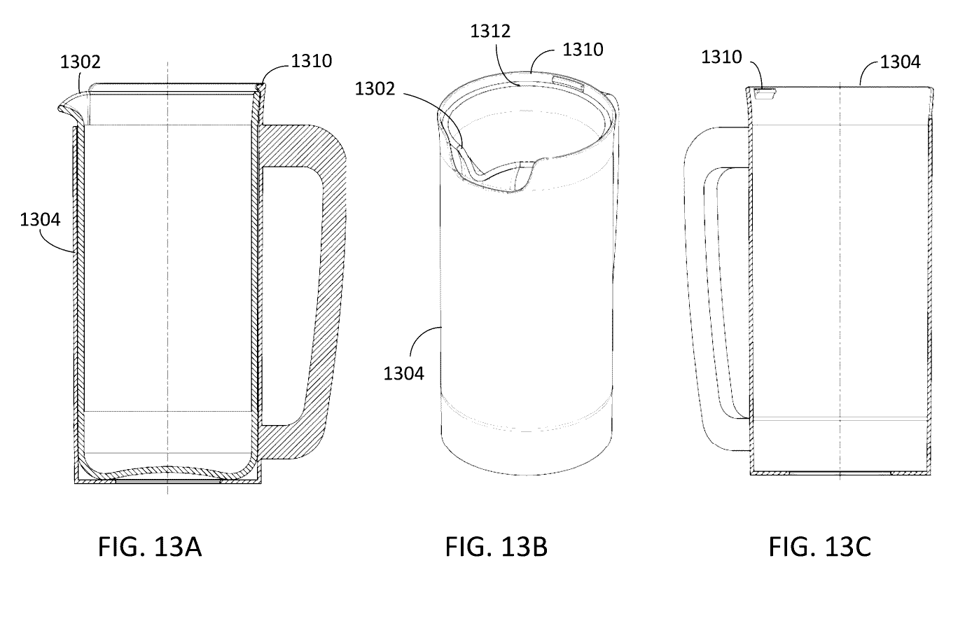

FIGS. 13A-13C Illustrate another embodiment of the present invention, in which a hook placed at the top of the housing of a Beverage press is used to retain the container. FIG. 3A is a the cross-sectional view of a Beverage Press showing a container 1302 fitted into housing 1304. The housing 1304 includes a hook fastener 1310 on the rim of the housing. The hook may be 0.5 to 2 cm. in width along the circumference of the rim. The hook fastener 1310, which may be made of a flexible material having some spring-like resiliency, may be distended or compressed sufficiently to allow the container 1302 to be inserted underneath the fastener; after distension or compression, the hook fastener may then snap back to provide a snap fit connection that secures the container 1302 within the housing 1304. The container 1302 is removable by pressing and distending or compressing the hook fastener 1310 backwards a small but sufficient distance (e.g., 1-2 mm.) to release the container. FIG. 13B is an isometric view showing the hook fastener 1310 in contact with the upper rim 1312 of the container. FIG. 13C is a rotated cross-sectional view which more clearly depicts an embodiment of the hook fastener 1310 positioned along the top rim of the housing 1304.

Although the present disclosure herein has been described with reference to particular preferred embodiments thereof, it is to be understood that these embodiments are merely illustrative of the principles and applications of the disclosure. Therefore, modifications may be made to these embodiments and other arrangements may be devised without departing from the spirit and scope of the disclosure.

What is claimed is:

1. A Beverage press apparatus comprising:
a substantially cylindrical container having an external side including a protruding element; and
a housing circumferentially enclosing the container, the housing having an aperture;
wherein the container may be inserted or removed from the housing when the protruding element is aligned with the aperture of the housing; and
wherein, when the protruding element is not aligned with the aperture, axial movement of the container with respect to the housing is restricted.

2. The Beverage press apparatus of claim 1, wherein the protruding element comprises a ledge adapted to abut an edge of the housing.

3. The Beverage press apparatus of claim 1, wherein the protruding element is composed of ABS, the container is made of glass, and the protruding element is fixed to the external side of the container using an adhesive adapted to bond ABS to glass.

4. The Beverage press apparatus of claim 1, wherein the protruding element is part of and made from the same material as the container.

5. The Beverage press apparatus of claim 1, wherein the housing is radially extended in at least one portion so as to receive the protruding element.

6. The Beverage press apparatus of claim 1, wherein the housing includes a generally cylindrical portion, a handle and a flange at a point where the handle meets the cylindrical portion, and the aperture in the housing is positioned at the flange.

7. The Beverage press apparatus of claim 1, wherein the aperture in the housing comprises a hole on a bottom of the housing, the hole having a narrow portion with a first width and a wide portion with a second width, and the protruding element is positioned on a bottom of the container and includes a head portion having a width greater than the first width and less than the second width.

8. The Beverage press apparatus of claim 7, wherein the container may be rotated to position the protruding element in either the narrow or the wide portion of the hole, and when positioned within the narrow portion of the hole, axial motion of the container is restricted.

9. The Beverage press apparatus of claim 8, wherein the container is made of glass, the protruding element is made of ABS, and the protruding element is fixed to the bottom of the container using an adhesive adapted to bond ABS to glass.

10. A Beverage press apparatus comprising:
a substantially cylindrical container having an external side including a threaded protruding element on an external bottom surface of the container; and
a housing circumferentially enclosing the container, the housing having a threaded aperture on a bottom surface;
wherein the container may be rotatably inserted and fastened into the housing by fastening the threaded element onto the bottom of the housing.

11. The Beverage press apparatus of claim 10, wherein the threaded protruding element is located at approximately the center of the external bottom surface of the container, and the aperture is correspondingly positioned at approximately the center of the bottom of the housing.

12. A Beverage press apparatus comprising:
a substantially cylindrical container having an open top with a rim; and
a housing circumferentially enclosing the container, the housing having an inner surface including an inwardly protruding element housing;
wherein upon insertion the rim of the container forms a snap-fit connection with the protruding element of the housing.

13. The Beverage press apparatus of claim 12, wherein the protruding element is hook shaped.

14. The Beverage press apparatus of claim 12, wherein the protruding element forms and integral part of the housing.

15. The Beverage press apparatus of claim 12, wherein the protruding element is separate element affixed to the housing using an adhesive.

16. A Beverage press apparatus comprising:
a substantially cylindrical container;
a coupling element fixedly coupled to an external side of the container, the coupling element having a shaped surface;
a housing circumferentially enclosing the glass container having at least two flange elements; and
a handle having a first end, the first end having an extension with a surface adapted to fit into the shaped surface of the coupling element, the first end also adapted to fasten to one of a first of the at least two the flange elements, and a second end adapted to fasten to a second of the at least two flange elements;
wherein fastening either the first end of the handle to the first flange element or the second end of the handle to the second flange element restricts axial movement of the container.

17. The Beverage press apparatus of claim 16, wherein the coupling element is composed of ABS, the container is made of glass, and the coupling element and is fixed to the external side of the container using an adhesive adapted to bond ABS to glass.

18. The Beverage press apparatus of claim 16, wherein the first and second ends of the handle are adapted to fasten to respective first and second flange elements via a screw or a bolt.

19. The Beverage press apparatus of claim 16, wherein the coupling element is formed in the shape of a hook.

20. A method of retaining a cylindrical glass container in a Beverage press apparatus having a housing including an aperture, comprising:
providing a protruding element on an external side of the container;
aligning the protruding element with the aperture of the housing;
inserting the protruding element through the aperture; and
rotating the container within the housing such that the protruding element is not aligned with the aperture;
wherein the protruding element prevents axial movement of the container relative to the housing upon being rotated.

21. The method of claim 20, wherein the protruding element is composed of ABS, the container is made of glass, and the protruding element is affixed to the container using an adhesive adapted to bond ABS to glass.

22. The method of claim 20, wherein the protruding element includes a ledge which extends radially beyond at least a portion of the housing.

23. The method of claim 20, wherein the housing includes an extension adapted to receive the protruding element.
